(19) United States
(12) Patent Application Publication
(10) Pub. No.: US 2007/0247318 A1
(43) Pub. Date: Oct. 25, 2007

(54) Retained Foreign Object Detection System

(75) Inventors: Mark Pempsell, Bedford, TX (US); Robert O. Myers, Bixby, OK (US); Ryan Corley, Austin, TX (US); Michael D. Woodruff, Plano, TX (US); Robert G. Bolks, Tulsa, OK (US)

Correspondence Address: BAKER BOTTS L.L.P., 2001 ROSS AVENUE, SUITE 600, DALLAS, TX, 75201-2980, US

(73) Assignee: Medical D-Tect-Or LLC, Plano, TX (US)

(21) Appl. No.: 11/733,720

(22) Filed: Apr. 10, 2007

Related U.S. Application Data
(60) Provisional application No. 60/744,655, filed on Apr. 11, 2006.
(60) Provisional application No. 60/822,875, filed on Aug. 18, 2006.

(51) Int. Cl. G08B 13/14; G08B 23/00

(52) U.S. Cl. 340/572.8; 340/573.1

(57) ABSTRACT

A system is provided for the detection of items found in the operating room and/or more specifically left on or within the body cavity. Such items could include, but are not limited to, laparotomy sponges, disposables, operating room towels or surgical instruments. The items are conjoined with a form of an Electronic Article Surveillance (EAS) tag that may be either adhered or woven to the item or incorporated within the item during the manufacturing process. The system includes a multi-channel electromagnetic device, which may be a hand-held device, that when placed within proximity of the tagged item will sound an alarm. The device has a second electromagnetic mode of operation for the detection of metallic instruments. If the device is within the proximity of surgical metallic objects within the body cavity or waste bags the alarm will sound.

### CROSS-REFERENCE TO RELATED APPLICATIONS

This application claims the benefit of priority under 35 U.S.C. § 119(e) of U.S. Provisional Applications Ser. No. 60/744,655 filed Apr. 11, 2006 and Ser. No. 60/822,875 filed Aug. 18, 2006.

### TECHNICAL FIELD

This invention relates generally to electronic article surveillance system, field of harmonic location finders and metal detection systems and, more particularly, to a method of source tagging and detecting surgical instruments and disposables.

### BACKGROUND

Certain detection systems are generally known. These systems may, in certain circumstances, function differently from each other. Further, current implementations of these systems suffer from various shortcomings. Some of the generally known detection techniques include Electronic Article Surveillance (EAS), Radiofrequency Identification (RFID) and metal detector systems. These systems operate over a wide range of frequencies using continuous wave or different pulse modalities. Emission frequencies for devices currently in use range from tens of hertz (Hz) to several gigahertz (GHz). Identification of persons or objects improve the controlled transportation and logistics of various items, or improved security.

### SUMMARY

According to an example embodiment, a system for tagging surgical items and/or disposable devices includes a first portion tagged with an electronic article surveillance device and a second portion operable in conjunction with the first portion. The second portion may comprise a multi-functional electromagnetic detection device utilized to detect the tag of the first portion.

The detection device may comprise a hand-held electromagnetic device having two or more distinctive modes of operation. During one mode of operation the detection device is capable of detecting an EAS and/or resonant reflective tag embedded in or attached to a surgical instrument, disposable, operating towel and the like. When the detection device detects the particular tag in the body cavity, an alarm sounds. The detection device may be switched to a second mode of operation, according to which the device operates as a metal detector and is calibrated to detect items that are utilized in the operating room, such as scalpels, hemostats, drills surgical utensils and the like. When the desired item is detected in the body cavity, an alarm sounds. The alarms may be distinct to correspond to the particular type of detection mode and/or type of item being detected.

According to another embodiment of the invention, the detection device is equipped with a pressure-sensitive switch in or about a handle of the device allowing for activation of the device. To insure that the electromagnetic fields generated by the detection device do not affect the operation of medical equipment in the operating room or surrounding areas, the device is only be activated when an individual physically grasps the detection device. Once the individual has scanned the body cavity and released the detection device, the device automatically returns to a deactivated mode, no longer emitting an electromagnetic field.

Various embodiments may be used to detect an electronic article surveillance devices or specific metallic materials that may be left within the body cavity. Furthermore, a system according to at least one embodiment may be used as a metal detection system for scanning biomedical waste bags for surgical items used in or about the operating room or surrounding areas.

In other example embodiments, a method and apparatus for the detection of medical instruments and disposables within the body cavity are provided. In one embodiment, a system for the detection of surgical instruments includes an electronic tag comprising a non-linear element and an antenna, and a transmitter/receiver having a first antenna operable to transmit a first electromagnetic signal, and an second antenna operable to receive a second electromagnetic signal emitted by the electronic tag in response to the first electromagnetic signal. The second electromagnetic signal is a harmonic of the first electromagnetic signal.

Embodiments of the invention may provide a number of technical advantages. Embodiments of the invention may include all, some, or none of these advantages. In one embodiment, existing electronic article surveillance or resonant reflective tagging is utilized in which an EAS and/or resonant reflective tag is embedded in or attached to a surgical instrument, disposables, operating towels and the like. By integrating an EAS and/or resonant reflective tag during the manufacturing process or applying said tag post-manufacturing will allow for traceability of said tagged device to be detected by the multi-functional electromagnetic detection device.

Other technical advantages are readily apparent to one skilled in the art from the following figures, descriptions, and claims.

### BRIEF DESCRIPTION OF THE DRAWINGS

FIG. 1 is a plane view of the multi-functional electromagnetic hand held detection device according to one embodiment of the present invention;

FIG. 2 is a topographical view of a surgical gauze sponge, laparotomy sponge, operating towel, disposable or the like; and

FIG. 3 is a side view of a surgical instrument such as a scalpel, sutures needle, hemostats, clamps and the like.

### DETAILED DESCRIPTION

Various embodiments of the present invention may incorporate one or more types of detection techniques including Electronic Article Surveillance (EAS), Radiofrequency Identification (RFID) and metal detector technology, and improvements thereto.

These techniques may share certain characteristics. First, they may use electromagnetic fields to detect or communicate over a short distance (usually up to a few meters). Second, they may employ a defined detection zone through which the item or person being monitored passes. Third, for the general public, they may generally involve brief exposure times, typically up to a few seconds. Under certain circumstances longer lasting exposures up to a few minutes are possible. Fourth, for occupational exposures, extended exposure times up to the length of a work shift may occur.

The three above types of systems may differ in principle by the information content being transferred and the nature of the receivers on the “targets.” EAS and metal detector systems may be configured to respond by indicating the presence of the target within the detection area. RFID tags or transponders may be capable of transmitting more elaborate information such as identification codes, etc. The electromagnetic fields interact with special sensors (so called “tags”) for EAS, integrated circuit “chips” in RFID tags or transponders, and conductive objects for metal detectors.

An EAS system may operate, for example, as follows. A transmitter sends a signal at defined frequencies to a receiver. This creates a surveillance area, for example, at a check-out counter aisle or a retail store exit. Upon entering the area, a tag or label with special characteristics creates a disturbance, which is detected by the receiver. Various embodiments of the EAS system can vary according to the method by which the tag or label disrupts the signal.

The physics of a particular EAS tag and resultant EAS technology are among the factors which may be used to determines which frequency range is used to create the surveillance area. The particular desired configuration of the EAS system may range from very low to very high frequency (e.g., from 20 Hz to 2.45 GHz). Similarly, these different frequencies may play a role in establishing the features that effect operation and determine the exposure conditions of the customers and the employees at the site.

EAS market demands may be met by a system incorporating one or more of several types of identification technology. One example of the identification technology that may be used is Radio Frequency Identification Device (“RFID”) technology. One objective of the RFID system is to carry data in suitable transponders, which may be referred to as “tags,” and to retrieve this data by machine-readable means at a suitable time and place to satisfy a particular application. Data within the tag may provide identification for an item in manufacturing, goods in transit, a location or an individual. By including additional data, the system enables supporting applications through item-specific information or instructions immediately available upon reading the tag.

A system may include, in addition to the tags, “readers” for interrogating the tag and a communication subsystem for communicating the data to a host computer or information management system. A system may also include a facility for entering or programming data into the tag (e.g., if this is not undertaken at the source by the manufacturer). One or more antennas may be incorporated as a feature present in either, or both of, the reader and the tag. The antennas may contribute to the communication of information between the two elements and/or other elements in the system.

Another technology which may be incorporated into the EAS system is Radio Frequency (“RF”) technology. Certain RF systems are known and their details are not repeated here. According to at least one embodiment of the invention, an RF system tag or label may be provided in the form of a miniature disposable electronic circuit and antenna. This device may be attached to an item and configured to respond to a specific frequency emitted by a transmitter antenna. The response from the RF tag is then picked up by an adjacent receiver antenna. The RF tag response signal is processed and triggers an alarm when it matches predetermined criteria.

Operating frequencies for the RF subsystem may range, for example, from 2 to 10 MHz. In some embodiments, the RF subsystem may use a frequency sweep technique in order to deal with different tag frequencies. Depending upon the desired application and configuration, the transmitter and receiver may be combined in one antenna frame. This configuration may be referred to as a mono system. The RF system may apply pulse or continuous sweep techniques, or a combination of both. The mono system is may be used, for example, with hard labels.

The RF subsystem may be implemented in different ways. In some embodiments, the RF tag has a helical antenna etched from thin aluminum bonded to a piece of paper. At the end of the antenna is a small diode or RC network that causes the tag to emit a radio signal in response to the radio signal it receives.

The EAS system may also incorporate Electromagnetic (“EM”) technology. An EM system may be particularly useful, for example, in a retail chain or supermarket environment. In the EM system, a strip containing iron that can be magnetized and may or may not have an adhesive layer is attached to the merchandise. This strip is not removed at checkout, but simply deactivated by a scanner that uses a specific highly intense magnetic field. One of the advantages of the EM strip is it may be reactivated.

What may otherwise be referred to as an electromagnetic tag may, in fact, be a metal wire or ribbon that has a high permeability, making it easy for magnetic signals to flow through. When the tag is driven, flux is allowed to flow through the tag until it is saturated. When saturated from a magnetic perspective, the tag and its properties begin to resemble air. Saturation occurs abruptly and is an important part of the design. When an EM tag goes from an active state to a saturated state, the receiver detects the change in the amount of the signal picked up from the transmitter. Saturation may occur, for example, twice each cycle, once on the transmitter positive and once at the negative cycle. When these cycles occur, the system is checking for the special material used in the EM tag. A magnetic piece of semi-hard magnetic material is brought in contact with the active material to deactivate. When the material is magnetized, it saturates the tag thereby putting it into an inactive saturated state.

In other applications, an EM system may apply intensive low frequency magnetic fields generated by a transmitter antenna. When the EM tag passes through the gate, it transmits a unique frequency pattern. This patter is picked up by the adjacent receiver antenna. The small signal is processed, triggering the alarm when a predetermined signal is recognized. Because of the relatively weak response of the EM tag and the low frequency and intensive field required by the EM system, the EM antenna may be larger than that necessary for the EAS system.

The EAS system may also incorporate Acousto-Magnetic (“AM”) technology. The AM system allows for high-speed label application, and uses a transmitter to create a surveillance area where tags and labels are detected. The transmitter sends a radio-frequency signal (e.g., about 58 KHz) in pulses, which energizes a tag in the surveillance zone. When the pulse ends, the tag responds by emitting a single frequency signal. While the transmitter is off between pulses, the AM tag signal is detected by a receiver. A suitable microcomputer checks the AM tag signal detected by the receiver to insure it is at the right frequency and is time synchronized to the transmitter at the proper level and the correct repetition. If all criteria are met, the alarm activates.

The AM material used may be highly magnetostrictive. When the tag material is introduced to the magnetic field, it physically shrinks. The higher the magnetic field, the smaller the material becomes. As a result of driving the AM tag with a magnetic field, the tag is physically changed and driven at a mechanical resonant frequency, operating similarly to a tuning fork. The AM tag in most cases requires bias magnetic material in addition to active element material. The active material changes its physical property no matter which direction is characteristic of the magnetic field placed upon it. If the AM tag is driven with a frequency F, its physical size decreases as the magnetic field increases. Being driven at F, the AM tag is trying to work at 2F, at both positive and negative cycles of the drive signal, and the tag reduces in size. To get the tag to work at F, a bias field is used. The bias is provided by a semi-hard magnetic element in the label. When magnetized, the bias prevents the active element from reaching a zero-field condition. So, for the entire half of the drive signal, the tag shrinks. The tag then expands for the other half, resulting in the F response. When introduced to the surveillance zone, the transmitter in the gate energizes the material and causes it to resonate at F. The gate stops transmitting and listens for the F response. If detected, then the system sounds the alarm.

The EAS system may also incorporate metal detection technology. A metal detectors may be provided, which employs time-varying magnetic fields to sense the presence of a ferrous and/or conductive object within the field. This type of equipment is currently used by consumers for locating coins, relics, mineral deposits, etc., in commercial applications for locating metal objects in food, industrial waste, etc., and in security applications for weapons detection and loss prevention.

The metal detector may be provided in various forms. A stationary archway metal detector may be used to screen the entire body as the person walks through the device. A hand-held device may be used as a secondary detection means to pinpoint the location of a metal object on the body. An archway metal detector may employ low frequency electromagnetic sensing. Each side panel of the archway may contain, for example, one or more transmitting coils and/or one or more receiving coils. These are effectively air core coils whose electromagnet fields envelope the entire archway. The hand-held device may use, for example, non-modulating sign wave technology.

Recent advantages in metal detection technology have employed increasingly sophisticated electronics to provide reliable performance with improved sensitivity, discrimination and the ability to work in “electromagnetically noisy” environments. While individual systems generally use single frequencies or narrow band of frequencies, future applications may also exploit combinations of different frequency bands used simultaneously (although not necessarily exactly time and phase coincident).

The incorporated detection subsystems and techniques may employ inductive fields. Hence, there is a negligible propagating field and exposures of people are generally limited to near-field magnetic fields. A microwave system may use a predominantly short range propagating microwave field and the field-generating element may be, for example, a helical coil antenna or similar field generator. The field power levels may be relatively low and, although they do propagate, they are constrained in area by the antenna directivity.

Each of the various technologies may operates on different principles and have specific advantages and disadvantages. A “tower-centric” EAS approach may be incorporated, which utilizes multiple tag technologies rather than certain “tag-centric” models which are currently in use. Certain embodiments of the present invention are capable of being compatible with any EAS technology and/or metal detection system technologies, and may also include the future “tower-centric” and systematic advances in the metal detection technologies currently under development or other suitable future EAS or Metal Detection technologies which are developed in the future.

Although not so limited, certain embodiments of the present invention are directed particularly to the field of medicine. In at least one embodiment, a combination of EAS technologies is used in concert with a metal detection device. The metal detection device may be a hand-held device, but may be, in other embodiments, an archway device. At least one embodiment is directed toward detecting “retained foreign objects” such as medical devices or equipment, which may be inadvertently left within a body cavity during a medical procedure, such as a surgical procedure.

The majority of retained foreign objects left in the body cavity include gauze sponges, laparotomy sponges, operating tools and/or items and operating room towels and the like. These items are offered as examples only, and the various embodiments are not limited thereto. One or more embodiments incorporate a specifically-designed, customized, and/or improved EAS tag. The tag is incorporated on or within the medical device or equipment, such as surgical sponges and instruments This incorporation provides medical devices tagged for detection. In at least one embodiment, EAS detection technology is combined with metal detection technology and a detection device is provide which can transmit, receive, and/or process information corresponding to both technologies. The detection device may be, for example, a hand-held device, such as a scanning “wand.” Certain embodiments provide various combinations of the information communication technologies describer herein. As such, certain embodiments provide for improved detection of tags, tagged devices, and non-tagged devices within a body cavity in a comprehensive manner.

Various embodiments of a detection system may incorporate several variations of tags and tag technologies and a dual-technology detection device. However, the invention is not limited to dual-detection configurations. In one embodiment of the invention detection device (e.g., wand) is switchable between a first detection mode incorporating a first detection technology, and a second detection mode incorporating a second detection technology. The detection technologies may be selected from any of those described herein. As an example only, the first detection mode may incorporate RFID detection (e.g., to detect EAS-tagged medical devices), while the second detection mode incorporates metal detection.

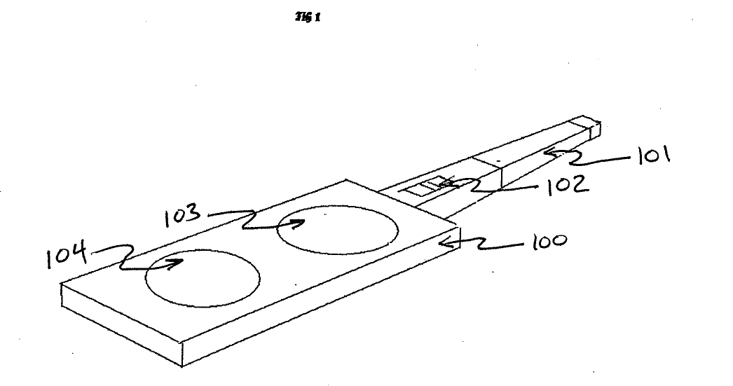

FIG. 1 is a plan view of a hand-held multi-functional electromagnetic detection wand 100. The multifunctional electromagnetic detection wand 100 incorporates several unique features. While the electromagnetic fields 104 and 105 are designed in such a manner as to not interfere with the operation of invasive and non-invasive medical devices there is a pressure sensitive activation switch 102 incorporated into the handle 101 of the wand 100 insuring that the wand 100 will only be in an active state when the operator has physically grasped the wand 100.

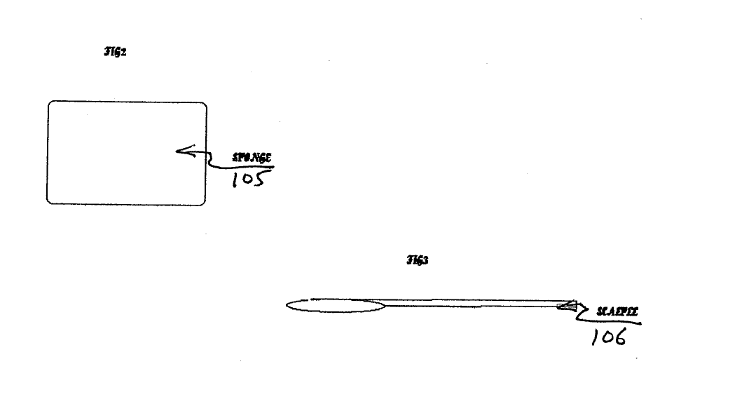

The wand 100 is equipped with two embedded electromagnetic devices 104 and 105. The electromagnetic device 104 is calibrated to both energize and receive signals for detection from FIG. 2, surgical items such as operating towels, surgical sponges, disposables or instruments 106 while in the activation mode. When the electromagnetic device 104 is activated and in the proximity of a tagged medical device 106 the detection wand 100 will sound an alarm. It is well known in the medical industry that each year there are numerous cases where surgical disposables and FIG. 3, surgical metallic instruments 107 are left within and inevitably closed within the body cavity.

The wand 100 is further equipped with a switch 103 to active from the embedded electromagnetic device 104 to the embedded electromagnetic metallic detection device 105. The metallic detection device 105 when energized by the activation switch 102 will detect surgical metallic object 107. When the electromagnetic metallic detection detector 105 is activated and in the proximity of surgical instruments 107 the alarm will sound. When the alarm sounds in either EAS tagged 106 modes or the medal detection 107 mode this is the indication that a medical devise 107 or disposable 106 has been misplaced within the body cavity. By detection of tagged utilities 106 and surgical instruments 107 prior to the closing of the body cavity will in fact save many lives each year and billions of dollars to the medical and insurance industries.

Another embodiment of the invention incorporates harmonic radar. When harmonic radar is tuned to detect a tag, which may comprises a low-barrier height Schottky barrier diode (SBD) or the like attached to a wire antenna, the harmonic radar device locates the tag and displays the location and/or movement of the tag. Accordingly, the transceiver may also be referred to as a “harmonic location finder.”

A harmonic radar device may comprise, for example, a transmitter/receiver unit that comprises of a 5-element yagi antenna for transmission and a 4-element patch array for reception. The harmonic radar device transmits a predetermined frequency by radiant means. When the low-barrier height SBD style tag or the like receives the signal from the harmonic radar device, the tag in turn becomes excited and begins to radiate at one or more frequencies pre-determined by its design. The harmonic radar device listens for the pre-determined signal. When the receiver has received the signal, it alerts the operator of the presence of the tag or tagged unit.

In an example embodiment, a method and apparatus for the detection of medical instruments and disposables within the body cavity are provided. In a particular embodiment, a system for the detection of medical equipment comprises an electronic tag comprising a non-linear element and an antenna, and a transmitter/receiver comprising an first antenna operable to transmit a first electromagnetic signal, and a second antenna operable to receive a second electromagnetic signal emitted by the electronic tag in response to the first electromagnetic signal. The second electromagnetic signal is a harmonic of the first electromagnetic signal.

In another particular embodiments, a method and apparatus for detecting surgical instruments and/or disposables that are inadvertently left within the body cavity are provided. According to an aspect of this embodiment, this detection of surgical instruments and/or disposables inadvertently left within the body cavity occurs prior to closing the body cavity after a surgical procedure.

It will be understood that the various embodiments of the present invention may include some, all, or none of the enumerated technical advantages. In addition other technical advantages of the present invention may be readily apparent to one skilled in the art from the description and claims included herein.

1. A retained foreign object detection system, comprising:
a surgical item;
an electronic article surveillance tag attached to or embedded within the surgical item; and
a multi-functional detection device operable to detect the electronic article surveillance tag and further operable to detect metallic items.

2. The system of claim 1, wherein the surgical item is selected from the group consisting of operating towels, sponges, surgical disposables, and surgical instruments.

3. The system of claim 1, wherein the surgical item includes a marking indicating the surgical item includes the electronic article surveillance tag.

4. The system of claim 3, wherein the marking comprises a colored thread sewn into the surgical item.

5. The system of claim 1, wherein the electronic article surveillance tag is selected from a group consisting of an RF tag, an RFID tag, an AM tag, an EM tag, and a tower-centric tag.

6. The system of claim 5, wherein the electronic article surveillance tag is one of a predetermined number of shapes and sizes.

7. The system of claim 5, wherein the electronic article surveillance tag is incased in a non-toxic material.

8. The system of claim 1, wherein the multi-functional detection device comprises a hand-held wand.

9. The system of claim 8, wherein the multi-functional detection device is activated by a pressure sensitive device located on a handle of the hand-held wand.

10. The system of claim 1, wherein the multi-functional detection device is operable to be switched between detecting the electronic article surveillance tag and detecting metallic items.

11. The system of claim 1, wherein the multi-functional detection device is operable to emit an audible sound when in the proximity of the electronic article surveillance tag.

12. The system of claim 1, wherein the multi-functional detection device is operable to emit an audible sound when in the proximity of a metallic item.

13. The system of claim 1, wherein the multi-functional detection device is operable to emit a first audible sound when in the proximity of the electronic article surveillance tag and a second audible sound when in the proximity of a metallic item.

14. The system of claim 1, wherein the multi-function detection device is operable to interact with a software module operable to track patient information.

15. A multi-functional detection device operable to detect an electronic article surveillance tag attached to or embedded within the surgical item, and further operable to detect metallic items.

16. The device of claim 15, wherein the electronic article surveillance tag is selected from a group consisting of an RF tag, an RFID tag, an AM tag, an EM tag, and a tower-centric tag.

17. The device of claim 15, wherein the surgical item is selected from the group consisting of operating towels, sponges, surgical disposables, and surgical instruments.

18. The device of claim 15, wherein the multi-functional detection device comprises a hand-held wand.

19. The device of claim 15, wherein the multi-functional detection device is activated by a pressure sensitive device located on a handle of the hand-held wand.

20. The device of claim 15, wherein the multi-functional detection device is operable to be switched between detecting the electronic article surveillance tag and detecting metallic items.

21. The device of claim 15, wherein the multi-functional detection device is operable to emit an audible sound when in the proximity of the electronic article surveillance tag.

22. The device of claim 15, wherein the multi-functional detection device is operable to emit an audible sound when in the proximity of a metallic item.

23. The device of claim 15, wherein the multi-functional detection device is operable to emit a first audible sound when in the proximity of the electronic article surveillance tag and a second audible sound when in the proximity of a metallic item.

24. A surgical item comprising an electronic article surveillance tag.

25. The surgical item of claim 24, wherein the surgical item is selected from the group consisting of operating towels, sponges, surgical disposables, and surgical instruments.

26. The surgical item of claim 24, wherein the surgical item includes a marking indicating the surgical item includes the electronic article surveillance tag.

27. The surgical item of claim 26, wherein the marking comprises a colored thread sewn into the surgical item.

28. The surgical item of claim 24, wherein the electronic article surveillance tag is selected from a group consisting of an RF tag, an RFID tag, an AM tag, an EM tag, and a tower-centric tag.

29. The surgical item of claim 28, wherein the electronic article surveillance tag is one of a predetermined number of shapes and sizes.

30. The surgical item of claim 28, wherein the electronic article surveillance tag is incased in a non-toxic material.

31. A patient tracking systems, compromising:
a first software module operable to receive patient data from an electronic article surveillance tag detection device operable to detect an electronic article surveillance tag attached to or embedded within a surgical item; and
a second software module operable to update a patient file with the patent data received from the electronic article surveillance tag detection device.

32. The patient tracking system of claim 31, wherein the patent data is selected from the group consisting of patient name, patient identification code, time, date, location, operating room locator, doctor name, support personal name, wand operator identification, time of detection device operation, and static of detention device operation.

33. The patient tracking system of claim 31 wherein the electronic article surveillance tag is selected from a group consisting of an RF tag, and RFID tag, an AM tag, and EM tag, and a tower-centric tag.

34. The patient tracking system of claim 31, wherein the surgical item is selected from the group consisting of operating towels, sponges, surgical disposables, and surgical instruments.

35. The patient tracking system of claim 31, wherein the patient file is stored on a hospital computer.

36. A system for the detection of surgical instruments, comprising:
an electronic tag, the electronic tag comprising a non-linear element and an antenna; and
a transmitter/receiver, the transmitter/receiver comprising an first antenna operable to transmit an first electromagnetic signal, and an second antenna operable to receive at second electromagnetic signal emitted by the electronic tag in response to the first electromagnetic signal;
wherein the second electromagnetic signal is a harmonic of the first electromagnetic signal.

37. The system of claim 36, wherein the non-linear element comprises a diode.

38. The system of claim 36, wherein the electronic tag further comprises flexible circuitry.

39. The system of claim 36, wherein the electronic tag is coupled to a surgical instrument.

40. The system of claim 36, wherein the electronic tag is coupled to a surgical disposable.

41. The system of claim 36, wherein the first antenna comprises a directional antenna.

42. The system of claim 36, wherein the second antenna comprises a directional antenna

43. The system of claim 36, wherein the first electromagnetic signal is frequency modulated along with another lower frequency.

44. The system of claim 36, wherein the first electromagnetic signal is amplitude modulated along with another lower frequency.

45. The system of claim 36, wherein the first electromagnetic signal comprises two frequencies.

46. The system of claim 36, wherein the first electromagnetic signal is modulated with a unique digital signal.

47. The system of claim 36, wherein the transmitter/receiver is operable to vary the frequency of the first electromagnetic signal over a range of predetermined frequencies.
